(19) United States
(12) Patent Application Publication
(10) Pub. No.: US 2024/0200737 A1
(43) Pub. Date: Jun. 20, 2024

(54) LAMP STRING

(71) Applicant: Linhai Lize Photoelectric Technology Co., Ltd., Taizhou (CN)

(72) Inventor: Chengzhuo YANG, Taizhou (CN)

(73) Assignee: Linhai Lize Photoelectric Technology Co., Ltd., Taizhou (CN)

(21) Appl. No.: 18/084,443

(22) Filed: Dec. 19, 2022

(51) Int. Cl. F21S 4/10; H05B 45/10

(52) U.S. Cl. CPC F21S 4/10; H05B 45/10; F21Y 2115/10

(57) ABSTRACT

Disclosed is a lighting string. The present application is designed to providing a lamp string with high reliability, which includes a parallel group of lamp strings, a male plug and a wire. The wire serves to connect the parallel group of lamp strings and the male plug. The parallel group of lamp strings includes a first series-connected lamp string group, a second series-connected lamp string group, . . . and an N-th series-connected lamp string group. The first to the N-th series-connected lamp string group each include a plurality of LED lamps connected by the wire in series. An adjustable resistor is disposed between the parallel group of lamp string and the male plug. The adjustable resistor has an adjustable resistance value ranging from 0 to one-third of a total resistance value of the LED lamps in the first series-connected lamp string group after being connected in series.

### TECHNICAL FIELD

The present application relates to the field of colored lights, in particular to a lamp string with high reliability.

### BACKGROUND

The LEDs of the existing LED strip are electrically connected in such a way that a plurality of LEDs are connected in parallel to form a parallel unit, and then a plurality of parallel units are connected in series. Such connection has the following disadvantages. 1. The wire connection is more cumbersome and takes up more space inside the light fixture, while making it difficult to form the desired pattern. 2. After multiple parallel groups are connected in series, the voltage of the power supply will drop several times after passing through the parallel units, which will cause the phenomenon that the brightness of the parallel units is not uniform. For the above shortcomings, a lamp string with high reliability is urgently needed.

### SUMMARY

Aiming at the shortcomings of the prior art, the present application provides a lamp string with high reliability.

To achieve the above purpose, the present application provides a technical solution as follows: a highly reliable light string includes a parallel group of lamp strings comprising a first series-connected lamp string group, a second series-connected lamp string group, . . . and an N-th series-connected lamp string group; a male plug; and a wire for connecting the parallel group of lamp strings and the male plug, wherein the first series-connected lamp string group, the second series-connected lamp string group, . . . and the N-th series-connected lamp string group each comprise a plurality of LED lamps connected by the wire in series.

The present application is further disposed as follows: an adjustable resistor is disposed between the parallel group of lamp string and the male plug.

The present application is further disposed as follows: the adjustable resistor has an adjustable resistance value ranging from 0 to one-third of a total resistance value of the LED lamps in the first series-connected lamp string group after being connected in series.

By adopting the technical solution, LED lamps are firstly connected in series to form a plurality of series-connected lamp string groups, then the series-connected lamp string groups are connected to the male plug after being connected in parallel, an adjustable resistor is also disposed on the male plug, where the number of LED lamps connected in series determines the working voltage of each LED, the number of the series-connected lamp strings connected in parallel can be determined according to the lighting requirements, the parallel-series connection (the lamp strings are connected in series and then in parallel) can ensure the reliability of the lamp strings, i.e., if the LED lamps in a lamp string fail, only the normal luminescence of the string group where the LED lamps are will be affected, and it can also ensure the matching with the power supply voltage, i.e., the working voltage of each series-connected lamp string group is the same, and the luminous brightness of the LED lamp is the same. An adjustable resistor is further disposed in the lamp string, which allows the overall luminous intensity of the LED lamp to be controlled by manually adjusting the resistance value of the adjustable resistor, so that different light and shade lighting effects can be created, thereby being applicable to different environments.

### BRIEF DESCRIPTION OF DRAWINGS

FIG. 1 is a structural schematic diagram of a lamp string with high reliability of the present application.

Reference signs in the drawing: 1. male plug; 2. adjustable resistor; 3. first series-connected lamp string group; 4. second series-connected lamp string group; 5. N-th series-connected lamp string group: 6. LED lamp.

### DETAILED DESCRIPTION OF THE EMBODIMENTS

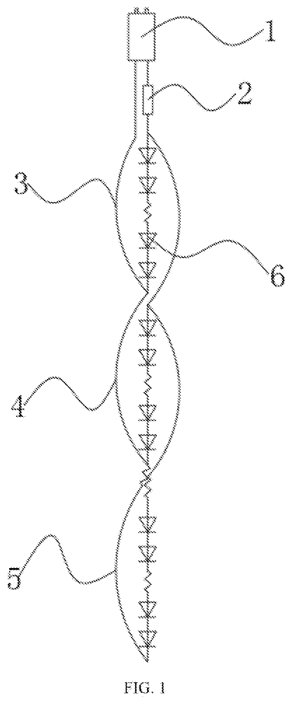

Referring to FIG. 1, the embodiment of a lamp string with high reliability of the present application is further explained.

For ease of illustration, spatially relative terms such as “above”, “below”, “left”, “right” and the like are used in the embodiments to illustrate the relationship of one element or feature shown in the drawings with respect to another element or feature. It should be understood that the spatial term is intended to encompass different orientations of the device in use or operation in addition to the orientations shown in the figures. For example, if the device in the figure is inverted, an element described as “below” another element or feature will be positioned “above” the another element or feature. Therefore, the exemplary term “below” may encompass both upper and lower directions. The device may be positioned in other ways (rotated 90 degrees or in other directions) and the space relative description used herein may be interpreted accordingly.

Moreover, relational terms such as “first” and “second” are used only to distinguish one component with the same name from another, without necessarily requiring or implying any such actual relationship or order between these components.

A light string with high reliability includes a parallel group of lamp strings, a male plug 1 and a wire. The wire serves to connect the parallel group of lamp strings and the male plug 1. The parallel group of lamp strings includes a first series-connected lamp string group 3, a second series-connected lamp string group 4, . . . and an N-th series-connected lamp string group 5. The first series-connected lamp string group 3, the second series-connected lamp string group 4, . . . and the N-th series-connected lamp string group 5 each include a plurality of LED lamps 6 connected in series. The LED lamps 6 are connected by the wire. An adjustable resistor 2 is disposed between the parallel group of lamp strings and the male plug 1. The lamp string is composed of N series-connected lamp string groups. The male plug 1 is connected with a power supply voltage of 31V. One adjustable resistor 2 is disposed between the male plug 1 and the lamp string. The resistance value of the adjustable resistor 2 is determined according to the total resistance value of the series-connected lamp string group. The voltage of the power supply voltage distributed on the series-connected lamp string group by adjusting the resistance value of the adjustable resistor 2, so as to control and adjust the brightness of the LED lamp 6. The adjustable resistor 2 has an adjustable resistance value ranging from 0 to one-third of a total resistance value of the LED lamps 6 in the first series-connected lamp string group 3 after being connected in series. The design of the resistance value of the adjustable resistor 2 can ensure that when the adjustable resistor 2 is at the maximum resistance value, the LED lamp 6 will not be too dark. When the resistance value of the adjustable resistor 2 is at the minimum resistance value, the LED lamp 6 lighting is bright. When the resistance value of the adjustable resistor 2 is between the minimum resistance value and the maximum resistance value, the LED is in different brightness states.

A plurality of series-connected lamp string groups can be provided. Targeted design can be made for different lighting requirements. One series-connected lamp string group is arranged in one lampshade. In the lamp string design mode of “connection in parallel first and then in series”, if one parallel lamp string group needs to be placed in each lampshade. the same number of connecting wires as the LED lamps 6 and two power wires are required. In the design mode of “connection in series first and then in parallel”, the number of wires in each lampshade is small, only two power wires and one series wire are needed, and the arrangement is relatively simple, which ensures that the lighting decoration effect of LED lamps 6 is not disturbed. Each series-connected lamp string group includes 10 LED lamps 6, and each lamp string includes 10*N LED lamps 6. Because of the large number of LED lamps 6, when the LED lamps 6 fail and need maintenance, this design mode of “connection in series first and then in parallel” can ensure that personnel can quickly and accurately locate the fault position and detect and replace the failure series-connected lamp string group.

As an independent unit, each series-connected lamp string group has a clear and concise internal connection circuit, which can better shape the overall lamp effect of the lamp string by arrangement of position of the lamp strings, so as to display the expected pattern through the lamp strings, and has higher practicability and adaptability.

The above is only a preferred embodiment of the present application and is not intended to limit the present application. The usual changes and replacements made by those skilled in the art within the technical solution scope of the present application should be encompassed in the scope of protection of the present application.

What is claimed is:

1. A lamp string comprising: a parallel group of lamp strings comprising a first series-connected lamp string group, a second series-connected lamp string group, . . . and an N-th series-connected lamp string group; a male plug; and a wire for connecting the parallel group of lamp strings and the male plug; wherein the first series-connected lamp string group, the second series-connected lamp string group, . . . and the N-th series-connected lamp string group each comprise a plurality of LED lamps connected by the wire in series.

2. The lamp string according to claim 1, wherein an adjustable resistor is disposed between the parallel group of lamp string and the male plug.

3. The lamp string according to claim 2, wherein the adjustable resistor has an adjustable resistance value ranging from 0 to one-third of a total resistance value of the LED lamps in the first series-connected lamp string group after being connected in series.
